(19) United States
(12) Patent Application Publication
(10) Pub. No.: US 2008/0128953 A1
(43) Pub. Date: Jun. 5, 2008

(54) Workpiece dividing method utilizing laser beam

(76) Inventors: Yusuke Nagai, Tokyo (JP); Satoshi Kobayashi, Tokyo (JP); Hitoshi Hoshino, Tokyo (JP)

Correspondence Address: SMITH, GAMBRELL & RUSSELL, LLP, Suite 800, 1850 M Street, N. W., Washington, DC, 20036, US

(21) Appl. No.: 11/984,529

(22) Filed: Nov. 19, 2007

Related U.S. Application Data
(63) Continuation of application No. 10/846,515, filed on May 17, 2004, now abandoned.

(30) Foreign Application Priority Data
May 19, 2003 (JP) 2003-140888

(51) Int. Cl. B29C 35/08

(52) U.S. Cl. 264/400

(57) ABSTRACT

A workpiece dividing method comprising applying a laser beam from one surface side of a workpiece permeable to the laser beam. The laser beam applied from the one surface side of the workpiece is focused onto the other surface of the workpiece or its vicinity to deteriorate a region ranging from the other surface of the workpiece to a predetermined depth. The deterioration of the workpiece is substantially melting and resolidification.

### FIELD OF THE INVENTION

This invention relates to a workpiece dividing method utilizing a laser beam, which is suitable for dividing a thin plate member, namely a wafer, including, although not limited to, any one of a sapphire substrate, a silicon carbide substrate, a lithium tantalate substrate, a glass substrate, a quartz substrate, and a silicon substrate, in particular.

### DESCRIPTION OF THE PRIOR ART

In the production of a semiconductor device, as is well known, many semiconductor circuits are formed on the surface of a wafer, including a substrate such as a sapphire substrate, a silicon carbide substrate, a lithium tantalate substrate, a glass substrate, a quartz substrate, or a silicon substrate, and then the wafer is divided to form individual semiconductor circuits. Various methods utilizing a laser beam have been proposed for dividing the wafer.

In the dividing method disclosed in U.S. Pat. No. 5,826,772, a laser beam is focused on one surface, or its vicinity, of a wafer, and the laser beam and the wafer are relatively moved along a division line. By this action, the material on the one surface side of the wafer is melted away along the division line to form a groove on the one surface of the wafer. Then, a bending moment is applied to the wafer to break the wafer along the groove.

U.S. Pat. No. 6,211,488 and Japanese Patent Application Laid-Open No. 2001-277163 each disclose a dividing method which comprises focusing a laser beam onto an intermediate portion in the thickness direction of a wafer, relatively moving the laser beam and the wafer along a division line, thereby generating an affected or deteriorated zone in the intermediate portion in the thickness direction of the wafer along the division line, and then applying an external force to the wafer to break the wafer along the deteriorated zone.

The dividing method disclosed in the above-mentioned U.S. Pat. No. 5,826,772 poses the problems that the material melted away on the one surface side of the wafer (so-called debris) scatters over and adheres onto the one surface of the wafer, thereby staining the resulting semiconductor circuits; and that it is difficult to make the width of the resulting groove sufficiently small, thus requiring a relatively large width of the division line, resulting necessarily in a relatively low percentage of the area usable for the formation of the semiconductor circuits.

The dividing methods disclosed in the U.S. Pat. No. 6,211,488 and Japanese Patent Application Laid-Open No. 2001-277163 have the following problems: According to experiments conducted by the inventors of the present application, deterioration of the material at the intermediate portion in the thickness direction of the wafer generally requires that a laser beam having a power density not less than a predetermined power density be directed at the wafer. The deterioration of the material leads to the formation of voids and cracks. The cracks can extend in arbitrary directions. Thus, when an external force is applied to the wafer, there is a tendency for the wafer not to be broken sufficiently precisely along the division line, with the result that many fractures may occur at the break edge or relatively large cracks may be caused.

### SUMMARY OF THE INVENTION

A principal object of the present invention is to provide a novel and improved workpiece dividing method utilizing a laser beam, which can divide a workpiece sufficiently precisely along a sufficiently narrow division line.

We, the inventors, conducted in-depth studies and experiments and, to our surprise, found the following facts: A laser beam is applied from one surface side of a workpiece, which is permeable to the laser beam, and is focused onto the other surface or its vicinity of the workpiece. By so doing, the material for the workpiece can be deteriorated in a region ranging from the other surface to a predetermined depth. Moreover, the deterioration can comprise, substantially, melting and resolidification of the material, without removal of the material, accordingly, with occurrence of debris being substantially avoided or sufficiently suppressed, and with occurrence of voids or cracks being substantially avoided or sufficiently suppressed. Hence, the above-mentioned principal object can be attained.

According to the present invention, for solving the above-described principal technical challenge, there is provided a workpiece dividing method comprising applying a laser beam from one surface side of a workpiece permeable to the laser beam,

further comprising focusing the laser beam applied from the one surface side of the workpiece onto the other surface of the workpiece or its vicinity to deteriorate a region ranging from the other surface of the workpiece to a predetermined depth.

It is preferred for the deterioration of the workpiece to be substantially melting and resolidification.

It is preferred that the laser beam be focused on a position +20 to −20 μm from the other surface of the workpiece when measured inwardly in the thickness direction. Preferably, the laser beam is a pulse laser beam having a wavelength of 150 to 1,500 nm, and a peak power density at the focused spot, i.e. focal point, of the pulse laser beam is 5.0×10⁸ to 2.0×10¹¹ W/cm². It is preferred that the workpiece is deteriorated at many positions spaced by a predetermined distance along a predetermined division line, and the predetermined distance is preferably not larger than 3 times a spot diameter at the focused spot of the pulse laser beam. The workpiece can be deteriorated at many positions spaced by a predetermined distance along a predetermined division line, then the focused spot of the laser beam can be displaced inwardly in the thickness direction of the workpiece, and the workpiece can be deteriorated again at many positions spaced by a predetermined distance along the predetermined division line, whereby the depth of the deteriorated region can be increased. The predetermined depth is preferably 10 to 50% of the total thickness of the workpiece. The workpiece may be a wafer including any one of a sapphire substrate, a silicon carbide substrate, a lithium tantalate substrate, a glass substrate, and a quartz substrate.

### BRIEF DESCRIPTION OF THE DRAWINGS

FIG. 1 is a schematic sectional view showing the mode of applying a laser beam to a workpiece in a preferred embodiment of the present invention.

FIG. 2 is a schematic sectional view showing, in an enlarged manner, the vicinity of the focused spot of the laser beam in FIG. 1.

FIG. 3 is a schematic sectional view showing the mode of FIG. 1 by a section along a division line.

FIG. 4 is a schematic sectional view, similar to FIG. 3, showing the mode of generating deterioration regions superposed in the thickness direction of the workpiece.

FIG. 5 is a schematic view prepared by sketching a photomicrograph of the break edge of a workpiece in Example 1.

FIG. 6 is a schematic view prepared by sketching a photomicrograph of the break edge of a workpiece in Example 2.

FIG. 7 is a schematic view prepared by sketching a photomicrograph of the break edge of a workpiece in Comparative Example 2.

### DETAILED DESCRIPTION OF THE PREFERRED EMBODIMENTS

Preferred embodiments of the workpiece dividing method according to the present invention will now be described in greater detail by reference to the accompanying drawings.

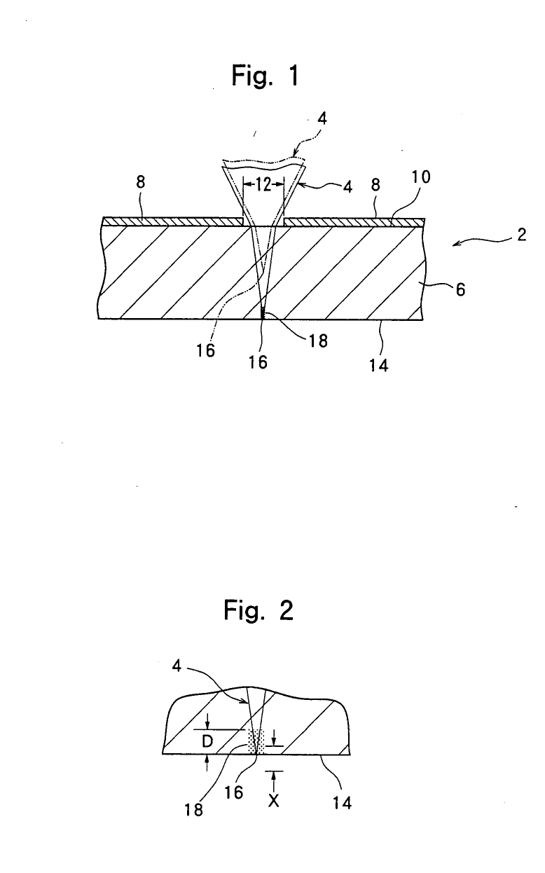

FIG. 1 schematically shows the mode of applying a laser beam 4 to a workpiece 2 to be divided. The illustrated workpiece 2 is a wafer composed of a substrate 6 in the form of a thin plate and many surface layers 8 (two of them are partially illustrated in FIG. 1). The substrate 6 is formed, for example, from sapphire, silicon carbide, lithium tantalate, glass, quartz, or silicon. The surface layers 8 are each rectangular in shape, and are stacked on one surface 10 of the substrate 6 in rows and columns. Streets (i.e. division lines) 12 arranged in a lattice pattern are defined between the surface layers 8.

In the dividing method of the present invention, the laser beam 4 is applied from the one surface side of the workpiece 2, namely, from above in FIG. 1. It is important for the laser beam 4 to be capable of permeating the substrate 6 to be divided. If the substrate 6 is formed of sapphire, silicon carbide, lithium tantalate, glass, or quartz, the laser beam 4 is advantageously a pulse laser beam having a wavelength of 150 to 1,500 nm. In particular, the laser beam 4 is preferably a YVO4 pulse laser beam or a YAG pulse laser beam having a wavelength of 1,064 nm. With reference to FIG. 2, a partial enlarged view, along with FIG. 1, it is important in the dividing method of the present invention that the laser beam 4 applied from the one surface side of the workpiece 2 via a suitable optical system (not shown) is focused on the other surface (i.e. the lower surface in FIGS. 1 and 2) of the workpiece 2 or its vicinity. The focused spot 16 of the laser beam 4 is preferably located on the other surface 14 of the workpiece 2, or within X, which ranges between +20 and −20 μm, especially between +10 and −10 μm, from the other surface 14 when measured inwardly in the thickness direction. In the illustrated embodiment, the one surface 10 of the substrate 6, on which the surface layers 8 are disposed, is directed upwards, and the laser beam 4 is applied from above the substrate 6. If desired, however, the one surface 10 of the substrate 6, on which the surface layers 8 are disposed, may be directed downwards (namely, the one surface 10 and the other surface 14 may be inverted), the laser beam 4 may be applied from above the substrate 6, and the laser beam 4 may be focused on the one surface 10 or its vicinity.

The descriptions of the Examples and Comparative Examples to be offered later show the execution of the dividing method of the present invention and those disclosed in the aforementioned U.S. Pat. No. 6,211,488 and Japanese Patent Application Laid-Open No. 2001-277163. When the laser beam 4 applied from the one surface side of the workpiece 2 is focused on an intermediate portion in the thickness direction of the workpiece 2 according to the methods of these patent documents, as indicated by dashed double-dotted lines in FIG. 1, no change occurs in the workpiece 2, if a peak power density at the focused spot 16 of the laser beam 4 is not more than a predetermined value. If the peak power density at the focused spot 16 of the laser beam 4 exceeds the predetermined value, voids and cracks are abruptly generated within the workpiece 2 near the focused spot 16 of the laser beam 4. When the laser beam 4 is focused on the other surface 14 of the workpiece 2 or its vicinity according to the method of the present invention, as indicated by solid lines in FIG. 1, on the other hand, the following phenomenon has been found to take place: The material for the workpiece 2 is melted in a region, which ranges from the other surface 14 of the workpiece 2 to a predetermined depth, with the peak power density at the focused spot 16 of the laser beam 4 being somewhat lower than the above predetermined value. Upon completion of the application of the laser beam 4, the melted material is solidified again. In FIGS. 1 and 2, a deterioration region 18 subject to melting and resolidification is shown marked with many dots. In such melting and resolidification, the removal and scatter of the material from the workpiece 2 can be substantially avoided or sufficiently suppressed, and the occurrence of voids and cracks can be substantially avoided or sufficiently suppressed. In the deterioration region 18 with a predetermined width and a limited depth, the material can be melted and resolidified. The reason why the behavior of the material changes according to the position of the focused spot 16 of the laser beam 4 is not necessarily clear, but we presume as follows: In the intermediate portion in the thickness direction of the workpiece 2, a constraining force on atoms is relatively great, so that the atoms, which have been excited by absorbing the laser beam 4 exceeding the predetermined power density, are burst to produce voids or cracks. On the other surface 14 of the workpiece 2 or its vicinity, by contrast, the constraining force on the atoms absorbing the laser beam 4 is relatively low. Thus, when absorbing the laser beam 4 with a power density less than the predetermined power density, the atoms do not burst, but cause the melting of the material. Moreover, the laser beam 4 permeates the interior of the workpiece 2 and arrives at the focused spot 16. Thus, the power of the laser beam 4 is not distributed outward from the workpiece 2 as during focusing of the beam onto the one surface of the workpiece 2, but is distributed while fanning toward the interior of the workpiece 2. Hence, melting of the material proceeds inwardly from the other surface 14. Scatter of the melted material is thus presumed to be sufficiently suppressed. The peak power density at the focused spot 16 of the pulse laser beam 4 focused onto the other surface 14 of the workpiece 2 or its vicinity depends on the material for the workpiece 2. Generally, it is preferred that the peak power density is on the order of 5.0×10⁸ to 2.0×10¹¹ W/cm².

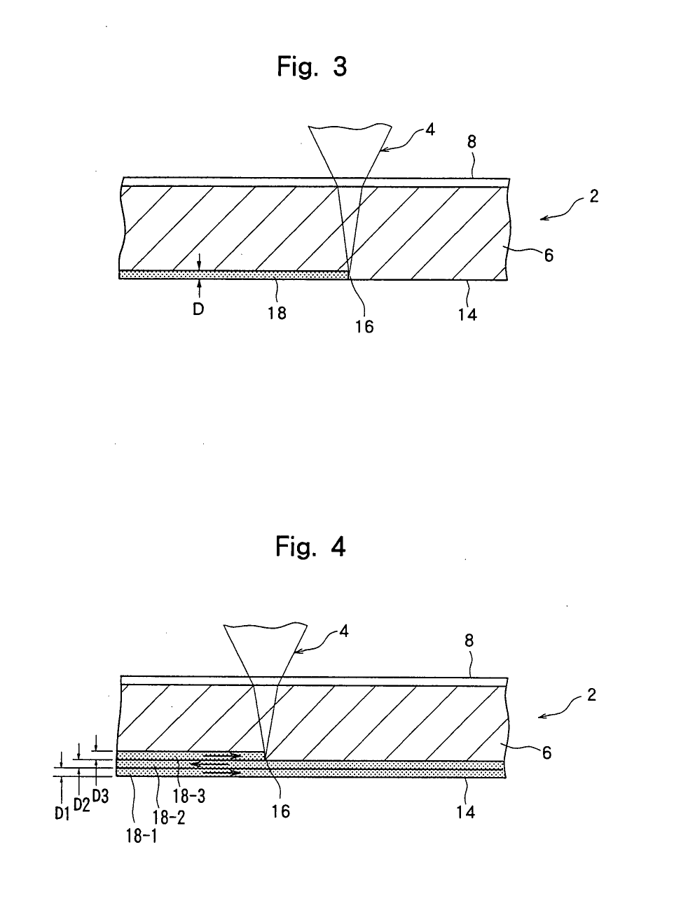

With reference to FIG. 3 along with FIG. 1, in the preferred embodiment of the present invention, the laser beam 4 applied from the one surface side of the workpiece 2 is focused on the other surface 14 or its vicinity. In this condition, the workpiece 2 and the laser beam 4 are relatively moved along the division line 12, whereby the deterioration region 18, which has substantially undergone melting and resolidification, is generated in the workpiece 2 at many positions spaced by a predetermined distance along the division line 12. The relative movement speed of the workpiece 2 and the laser beam 4 is preferably set such that the predetermined distance is not more than 3 times the spot diameter of the focused spot 16 of the laser beam 4. As shown in FIG. 3, therefore, the deterioration region 18 with a predetermined depth D from the other surface 14 is generated on the other surface side of the workpiece 2 at some intervals or substantially continuously along the division line 12. The deterioration region 18 is locally decreased in strength in comparison with the other portions. Thus, the deterioration region 18 is generated at some intervals or substantially continuously along the entire length of the division line 12, and then, for example in Example 1, both sides of the division line 12 are urged upward or downward to apply a bending moment to the workpiece 2 about the division line 12. By this procedure, the workpiece 2 can be broken sufficiently precisely along the division line 12. For ease of breakage of the workpiece 2, the depth D of the deterioration region 18 is preferably about 10 to 50% of the total thickness T at the division line 12 of the workpiece 2.

To generate the deterioration region 18 of the required depth D, the laser beam 4 can be applied a plurality of times, if desired, with the position of the focused spot 16 of the laser beam 4 being displaced. FIG. 4 shows this mode of laser beam application to displaced positions which is carried out in the following manner: Initially, the laser beam 4 is moved rightward relative to the workpiece 2, with the focused spot 16 of the laser beam 4 being located on the other surface 14 of the workpiece 2 or its vicinity, whereby a deterioration region 18-1 of a depth D1 is generated along the division line 12. Then, the laser beam 4 is moved leftward relative to the workpiece 2, with the focused spot 16 of the laser beam 4 being somewhat displaced inwardly (i.e. upwardly in FIG. 4) in the thickness direction of the workpiece 2, whereby a deterioration region 18-2 of a depth D2 is generated on the top of the deterioration region 18-1. Further, the laser beam 4 is moved rightward relative to the workpiece 2, with the focused spot 16 of the laser beam 4 being somewhat displaced inwardly (i.e. upwardly in FIG. 4) in the thickness direction of the workpiece 2, whereby a deterioration region 18-3 of a depth D3 is generated on the top of the deterioration region 18-2.

Next, the Examples and Comparative Examples of the present invention will be described.

### Example 1

A sapphire substrate with a diameter of 2 inches (5.08 cm) and a thickness of 100 μm was used as a workpiece. In accordance with the mode illustrated in FIGS. 1 to 3, a laser beam was applied from one surface side of the workpiece, namely, from above, to generate a deterioration region along a predetermined division line. The application of the laser beam was performed under the following conditions, with the focused spot, i.e. focal point, of the laser beam being located on the other surface, i.e. lower surface, of the workpiece:

### Laser

YVO4 pulse laser

Wavelength: 1064 nm

Spot diameter of focused spot: 1 μm

Pulse width: 25 ns

Peak power density of focused spot: 2.0×10¹¹ W/cm²

Pulse repetition frequency: 100 kHz

Speed of relative movement of laser beam (movement relative to the workpiece): 100 mm/second

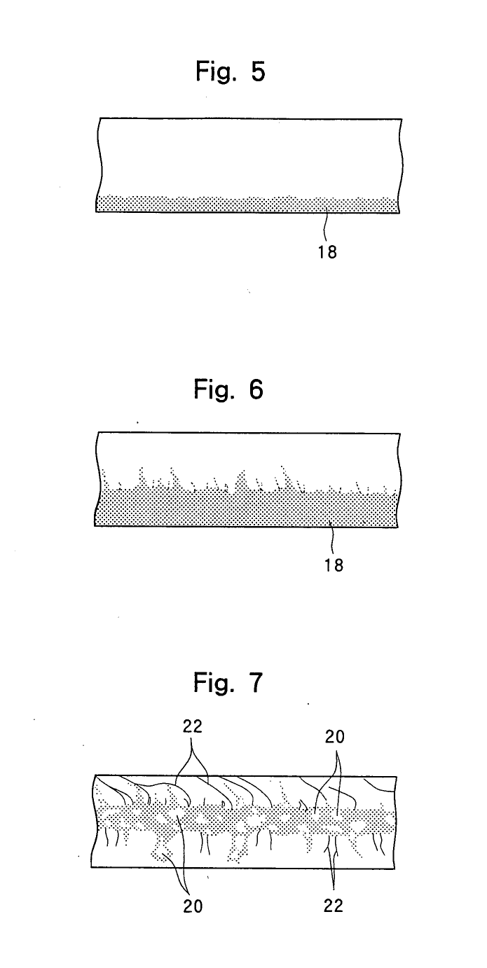

Then, the workpiece was gripped manually, and a bending moment was applied thereto about the division line to break the workpiece along the division line. Breakage was performed sufficiently precisely along the division line, and no marked fracture or the like was present at the break edge. FIG. 5 is a sketch of a photomicrograph (magnification ×200) of the break edge of the workpiece. As understood from FIG. 5, a deterioration region 18 of a depth of 10 to 20 μm was generated on the other surface side of the workpiece. Such a deterioration region was substantially free of voids or cracks.

### Example 2

The laser beam was applied in the same manner as in Example 1, except that after each movement of the laser beam relative to the workpiece along the division line, the position of the focused spot of the laser beam was displaced upward by 10 μm and, in this state, the laser beam was reciprocated twice (accordingly, moved 4 times) relative to the workpiece.

Then, the workpiece was gripped manually, and a bending moment was applied thereto about the division line to break the workpiece along the division line. Breakage was performed sufficiently precisely along the division line, and no marked fracture or the like was present at the break edge. FIG. 6 is a sketch of a photomicrograph (magnification ×200) of the break edge of the workpiece. As understood from FIG. 6, a deterioration region 18 of a depth of 40 to 50 μm was generated on the other surface side of the workpiece. Such a deterioration region was substantially free of voids or cracks.

### Comparative Example 1

For purposes of comparison, the laser beam was applied in the same manner as in Example 1, except that the focused spot of the laser beam was located at an intermediate portion in the thickness direction of the workpiece. The workpiece was observed after application of the laser beam, but the generation of a deterioration region was not noted.

### Comparative Example 2

The laser beam was applied in the same manner as in Comparative Example 1, except that the peak power density of the focused spot of the laser beam was increased to 2.5×10¹¹ W/cm².

Then, the workpiece was gripped manually, and a bending moment was applied thereto about the division line to break the workpiece along the division line. Breakage failed to be performed sufficiently precisely along the division line, and many fractures and relatively large cracks were present at the break edge. FIG. 7 is a sketch of a photomicrograph (magnification ×200) of the break edge of the workpiece. As understood from FIG. 7, a deterioration region generated in the intermediate portion in the thickness direction of the workpiece contained many voids 20 and cracks 22. The cracks were found to extend in various directions.

1-10. (canceled)

11. A workpiece dividing method for a workpiece that has first and second opposite sides and that is permeable to a laser beam, said method comprising:
applying the laser beam to a surface of said first side of the workpiece; and
focusing the laser beam applied to said first side through the workpiece to cause deterioration of a region from a surface of said second side of the workpiece to a predetermined depth within the workpiece.

12. The workpiece dividing method according to claim 11, wherein the deterioration of the workpiece is substantially melting and resolidification.

13. The workpiece dividing method according to claim 11, wherein the laser beam is focused on a position +20 to −20 μm from said other surface of the workpiece when measured inwardly in a thickness direction.

14. The workpiece dividing method according to claim 11, wherein the laser beam is a pulse laser beam having a wavelength of 150 to 1,500 nm.

15. The workpiece dividing method according to claim 14, wherein a peak power density at a focused spot of the pulse laser beam is 5.0×10⁸ to 2.0×10¹¹ W/cm².

16. The workpiece dividing method according to claim 14, wherein the workpiece is deteriorated at many positions spaced by a predetermined distance along a predetermined division line.

17. The workpiece dividing method according to claim 16, wherein said predetermined distance is not larger than 3 times a spot diameter at the focused spot of the pulse laser beam.

18. The workpiece dividing method according to claim 14, further comprising:
after causing deterioration in said region, displacing a focused spot of the laser beam inwardly in a thickness direction of the workpiece; and deteriorating the workpiece again on top of said region, along said predetermined division line, thereby increasing a depth of a resulting deteriorated region.

19. The workpiece dividing method according to claim 16, wherein said predetermined depth is 10 to 50% of a total thickness of the workpiece.

20. The workpiece dividing method according to claim 11, wherein the workpiece is a wafer including any one of a sapphire substrate, a silicon carbide substrate, a lithium tantalate substrate, a glass substrate, and a quartz substrate.
